(19) United States
(12) Patent Application Publication
(10) Pub. No.: US 2007/0062098 A1
(43) Pub. Date: Mar. 22, 2007

(54) Biodegradable bait box

(76) Inventor: Suzan J. Gentry, Hastings, MI (US)

Correspondence Address: JAMES RAY & ASSOCIATES, 2640 PITCAIRN ROAD, MONROEVILLE, PA, 15146, US

(21) Appl. No.: 11/490,940

(22) Filed: Jul. 21, 2006

Related U.S. Application Data
(60) Provisional application No. 60/718,443, filed on Sep. 19, 2005.

(51) Int. Cl. A01K 97/04

(52) U.S. Cl. 43/55

(57) ABSTRACT

An apparatus for use in carrying live bait by a fisherman that is friendly to the environment. The apparatus comprises a container member having a predetermined shape and formed of a first predetermined material, such first predetermined material being biodegradable. There is a lid for such container member that is formed of a second predetermined material. Such second predetermined material also being biodegradable and a plurality of perforations are disposed through such lid for providing air to such bait disposed in the container.

### CROSS REFERENCE TO RELATED APPLICATIONS

This application is closely related to and claims benefit from U.S. Provisional Application Ser. No. 60/718,443 filed Sep. 20, 2005.

### FIELD OF THE INVENTION

The present invention relates, in general, to a bait cup, and, more particularly, the present invention relates to a bait cup that can be used to store and carry live fishing bait that is biodegradable.

### BACKGROUND OF THE INVENTION

Fishing is a favorite outdoor activity for many persons and the popularity of fishing continues to escalate. For both sport and pleasure fishermen enjoy using live bait in specific areas when searching for a particular fish. Many of these fishermen use Styrofoam bait cups to carry their bait. These Styrofoam cups are probably the standard items that are used because they are inexpensive, handy to carry and hold numerous worms are sealable with a lid. Thus the bait is kept handy and easy to access which would seem to make it ideal. However, these cups are not environmentally sound. Styrofoam material is not biodegradable and, thus, many of these bait cups can be found, and usually are found, strewn around many of these fishing areas and can be found polluting many of the waterways. This is not only an eyesore but is also detrimental to the environment.

It would be highly desirable if there were bait cups available which would serve the purpose as do the Styrofoam cups of being able to carry numerous bait and be handy to use and yet be fully biodegradable.

### SUMMARY OF THE INVENTION

In a first aspect the present invention provides an apparatus for use in carrying live bait by a fisherman that is friendly to the environment. The apparatus comprises a container member having a predetermined shape and formed of a first predetermined material, such first predetermined material being biodegradable. There is a lid for such container member that is formed of a second predetermined material. Such second predetermined material also being biodegradable and a plurality of perforations are disposed container.

### OBJECTS OF THE INVENTION

It is, therefore, one of the primary objects of the present invention to provide a bait container that is environmentally friendly.

Another object of the present invention is to provide a bait container that is biodegradable.

Still another object of the present invention is to provide bait container that is can be used to store and carry live fishing bait.

Yet another object of the present invention is to provide a bait container that is shaped like a cup and having a lid secured thereon.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the apparatus according to an embodiment of the invention showing the container member with the lid in place.

FIG. 2 is a perspective view of the apparatus shown in FIG. 1 without the lid showing bait inside the container.

FIG. 3 is a perspective view of the lid used to close the container.

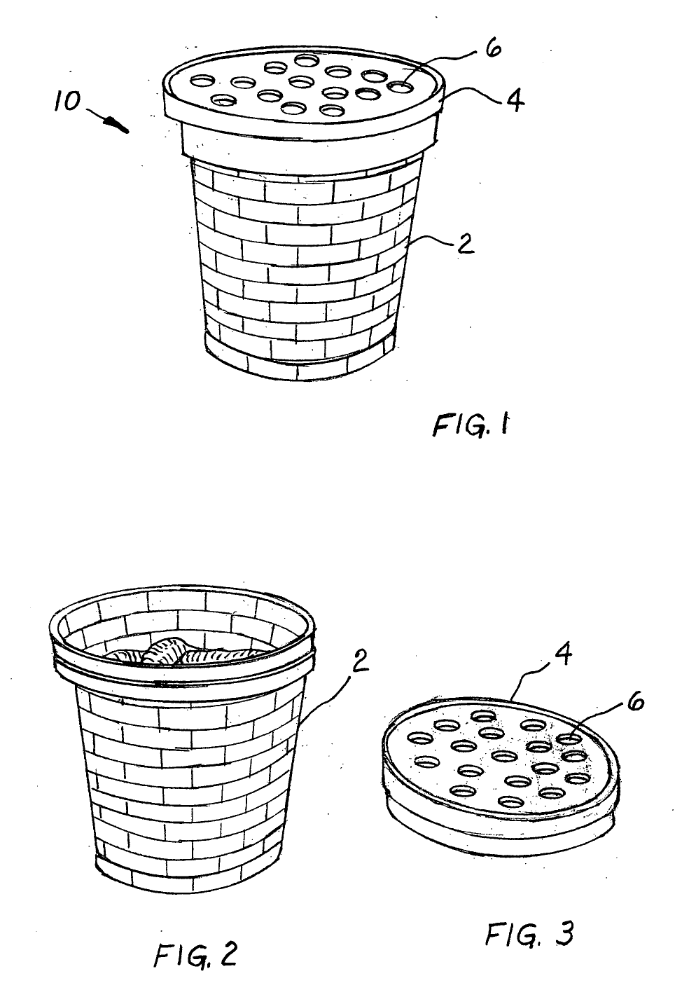

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for use in carrying live bait by a fisherman that is friendly to the environment. The apparatus 10 comprises a container member 2 having a predetermined shape and formed of a first predetermined material, such first predetermined material being biodegradable. There is a lid 4 for such container member that is formed of a second predetermined material. Such second predetermined material also being biodegradable. Such lid 4 has a plurality of perforations 6 disposed through such lid 4 for providing air to such bait disposed in the container 2.

Such first predetermined material being a biodegradable material it will decompose in the environment and is made of organic materials. One such organic material is pressed corn which is a presently preferred material for constructing such cups 2. Such material will degrade easily between fishing seasons and serve as food for such environment. In fact the pressed corn product will decompose in a relatively short period of time.

It is further preferred that such first predetermined material used for making the container 2 and such second predetermined material used for making the lid 4 made of substantially identical. materials. It is also preferred that such lid 4 snaps onto the container member 2 sand is secured thereto by means of a friction fit.

It is presently preferred that such predetermined shape of such container be substantially cylindrical, and it is even more preferred that such predetermined shape be substantially that of a truncated cone. This is similar to the shape of such Styrofoam cups that are presently used for drinking beverages.

The container member also has a predetermined size. It is presently preferred that such predetermined size is between about 2 inches and about 3 inches in length and even more preferred that such size is between about 2¼ inches and about 2¾ inches in length.

Further, it is preferred such container member has a diameter at a widest part of the truncated cone which is between about 4 inches and about 5 inches and even more preferred that such diameter at the widest part of the truncated cone be between about 4¼ inches and about 4¾ inches.

The present invention provides a bait box that is fully biodegradable and will easily decompose. Thus, such bait box will not only serve as a convenient bait container but as an environmentally sound product as well. Styrofoam bait cups are the standard bait keepers holding numerous worms and providing easy access to the bait as well. However, this container is not environmentally sound as can be seen with many of such cups strew around fishing areas and in the streams as well. The bait box made of biodegradable material will help alleviate the pollution of waterways caused by discarded plastic bait boxes and will help in keeping hunting and fishing and other outdoor sites clean and more enjoyable for all.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

I claim:

1. An apparatus for use in carrying live bait by a fisherman that is friendly to an environment, said apparatus comprising:
(a) a container member having a predetermined shape and formed of a first predetermined material, said first predetermined material being biodegradable;
(b) a lid for said container member formed of a second predetermined material, said second predetermined material being biodegradable; and
(c) a plurality of perforations disposed through said lid for providing air to such bait disposed in said container.

2. The apparatus, according to claim 1, wherein said predetermined shape of said container is substantially cylindrical.

3. The apparatus, according to claim 2, wherein said substantially cylindrical container is in a shape of a truncated cone.

4. The apparatus, according to claim 1, wherein said first predetermined material will degrade easily between fishing seasons and serve as food for such environment.

5. The apparatus, according to claim 1, wherein said first predetermined material is organic matter.

6. The apparatus, according to claim 5, wherein said organic matter is a pressed corn product.

7. The apparatus, according to claim 6, wherein said pressed corn product will decompose in a short period of time.

8. The apparatus, according to claim 1, wherein said first predetermined material and said second predetermined material are substantially identical.

9. The apparatus, according to claim 1, wherein said lid snaps onto said container member and is secured by a friction fit.

10. The apparatus, according to claim 2, wherein said container member has a predetermined size.

11. The apparatus, according to claim 10, wherein said predetermined size of said container member is between about 2 inches and about 3 inches in length.

12. The apparatus, according to claim 11, wherein said predetermined size of said container member is between about 2¼ inches and about 2¾ inches in length.

13. The apparatus, according to claim 10, wherein said container member has a diameter at a widest part of said truncated cone is between about 4 inches and about 5 inches.

14. The apparatus, according to claim 13, wherein said diameter at said widest part of said truncated cone is between about 4¼ inches and about 4¾ inches.
